(19) United States
(12) Patent Application Publication
(10) Pub. No.: US 2018/0362361 A1
(43) Pub. Date: Dec. 20, 2018

(54) Drinking Water Filter

(71) Applicant: Virgil L. Archer, Englewood, CO (US)

(72) Inventor: Virgil L. Archer, Englewood, CO (US)

(21) Appl. No.: 15/628,542

(22) Filed: Jun. 20, 2017

(51) Int. Cl. C02F 1/00; C02F 1/28; C02F 1/42

(52) U.S. Cl. CPC C02F 1/003; C02F 1/288; C02F 1/281; C02F 1/00; C02F 1/42; C02F 2201/006; C02F 1/283

(57) ABSTRACT

An improved water filter with water filter cartridge having an intake micron pad used for the initial filtering of large contaminates, such as rust, and a discharge micron pad used for removing any remaining floating contaminants and giving the treated water a sparkling clarity. Ion exchange fibers are disposed below the intake micron pad and are used for filtering out heavy metals, such as copper, mercury and lead. Below the Ion exchange fibers is a combination of resins to provide additional protection by filtering out copper, mercury and lead from the tap water. Disposed below the resins is a mixture a hybrid anti-arsenic sorption, an anion exchange resin and an inorganic component for removing phosphate and sulfate anions and inorganic arsenic. Disposed below the inorganic component is a layer of silver impregnated activated carbon and non-washed and washed activated carbon and disposed above the discharge micron pad.

### BACKGROUND OF THE INVENTION

### (a) Field of the Invention

This invention relates to an improved drinking water filter and more particularly, but not by way of limitation, to a drinking water filter having a sealed water filter cartridge received in a cartridge housing for filtering major water contaminates, particularly inorganic arsenic and lead, from tap water from a municipal water supply and other water sources. The filtered tap water is used for drinking, cooking, washing and other household uses.

### (b) Discussion of Prior Art

During the past few years, the American public has become increasingly concerned about Government agencies capability of following through in helping consumers receive safe water. For example, the municipal water supply in Flint, Mich. failed to protect residents from lead poising from outdated water pipes.

In U.S. Pat. No. 6,197,193 to the inventor of the subject improved water filter cartridge, a similar water filter is described having a cylindrical hollow filter cartridge with a combination of filter pads, a layer of granulated zinc and copper alloy, a layer of granulated activated carbon, a layer of ion exchange resin and a layer of granulated calcite. The subject water filter cartridge is a substantial improvement over the water filter described in this patent.

In U.S. Pat. No. 753,780 to Woods, a water filter is described and used with a hand pump for pumping water from a water well. The filter includes a series of perforated plates, layers of sand, charcoal and sponges. In U.S. Pat. No. 4,913,808 to Haque, an interchangeable water purification system is disclosed having a cartridge with layers of activated carbon and a layer of ion exchange resin. In U.S. Pat. No. 5,643,444 to Garrigues et al., U.S. Pat. No. 5,252,206 to Gonzales, U.S. Pat. No. 4,368,123 to Stanley and U.S. Pat. No. 5,685,981 to Koslow, different types of water filters, counter top water conditioners and filtration cartridges are described.

None of the above-mentioned prior art patents specifically disclose or teach the unique features and advantages of the subject improved drinking water filter used with a tap water supply as described herein.

### SUMMARY OF THE INVENTION

In view of the foregoing, it is a primary objective of the subject invention to provide an improved drinking water filter used for various household uses and in particular removing inorganic arsenic and lead from tap water. Also, the water filter can be used for commercial and industrial applications where treated drinking, cooking and washing water is desired or required. The water filter provides a consumer with protection against major water contaminants found in municipal water supplies and other drinking water sources.

Another object of the invention is the water filter removes contaminants in the water below E.P.A. recommended minimum levels.

Yet another object of drinking water filter is the filter is designed to remove large and small sediments in the water using micron pads. Also the filter cartridge uses a mixture of washed and non-washed activated carbon and an anion exchange resin to remove chlorine, trihalomethanes, hydrogen sulfide, pesticides, herbicides, toxic heavy metals (such as lead, mercury, arsenic and others), cancer-causing organic pollutants, micro-organisms, and other foreign particles and organisms.

Yet another object of the water filter is the treated water has a sparkling clarity by screening material out of the water down to a 5 micron size.

Further, the water filter requires no plumbing and the water filter cartridge is received in a portable cartridge filter housing attached to a standard water faucet. The filter housing can be placed upright on a counter top for household use. Also, the water filter housing can be attached to a water supply line and mounted under a kitchen sink.

The drinking water filter costs pennies per 8 oz. glass, is compact and space saving in design. It eliminates the need to buy, lift and carry heavy water bottles. The water filter cartridge has a filter life of treating 800 gallons of tap water, which is a typical one year average drinking and cooking water use of a family of four. The water filter cartridge can be quickly and easily replaced from inside the filter cartridge housing.

The improved drinking water filter includes a cylindrical hollow filter cartridge for receiving a sealed water filter cartridge. The filter cartridge includes intake port holes for receiving tap water and a single discharge port hole for discharging the treated tap water. The cartridge includes an intake micron pad for filtering out floating contaminates, such as rust. Also, the cartridge includes a discharge micron pad for removing any remaining floating contaminates and giving the treated water sparkling clarity.

Ion exchange fibers are disposed below the intake micron pad. Below the Ion exchange fibers are a combination of a mixture of a cation exchange resin, in a H plus or minus form, and a cation exchange resin, in a Na plus or minus form. Disposed below the cation exchange resins is a large amount of a mixture of a hybrid anti-arsenic sorption, an anion exchange resin and an inorganic component. Below this mixture is a small amount of a silver impregnated activated carbon. Disposed below the silver activated carbon is a mixture of non-washer and washed activated carbon and placed above the discharge micron pad.

These and other objects of the present invention will become apparent to those familiar with various types of drinking water filters and water purifying systems when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the subject water filter cartridge, and in which:

FIG. 1 is a perspective view of the drinking water filter with filter cartridge housing in an upright position and a water filter cartridge received therein. A portion of the cartridge housing has been cutaway to illustrate the filter cartridge inside the housing.

FIG. 2 is a perspective view of the improved filter cartridge with various layers of compound mixtures used for purifying the tap water.

### DETAILED DESCRIPTION OF THE PREFERRED EMBODIMENTS

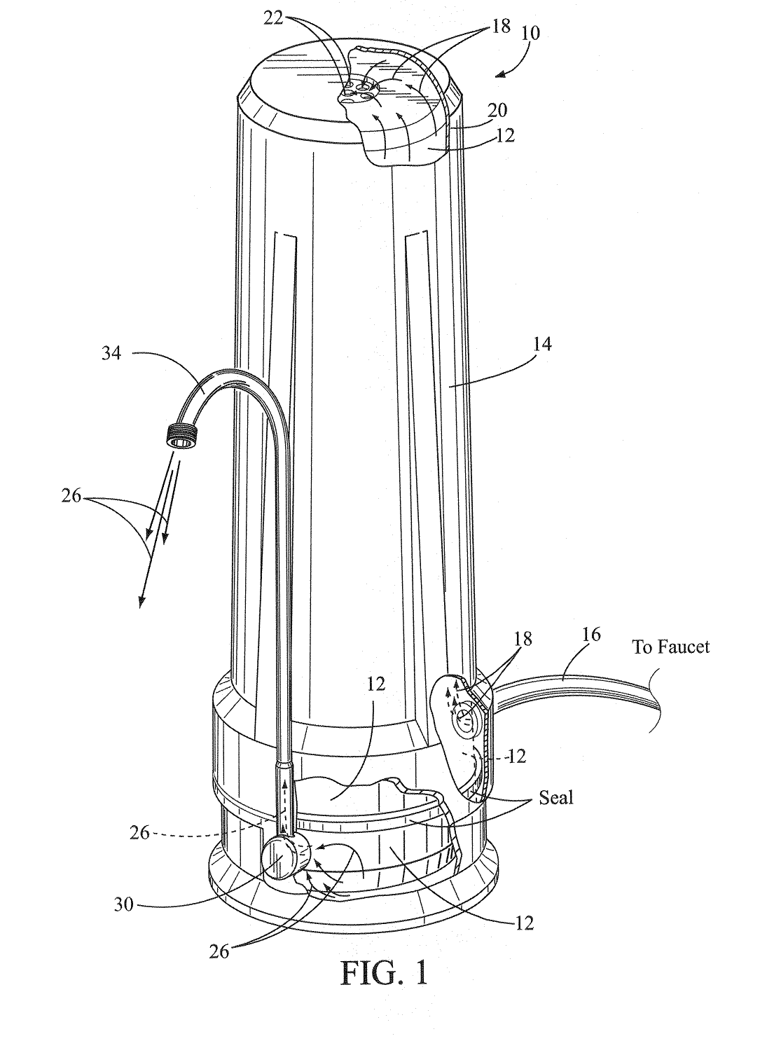

In FIG. 1, the subject improved drinking water filter is shown having general reference numeral 10. The drinking water filter 10 includes a cylindrical hollow filter cartridge 12 adapted for receipt in a water filter housing 14. The filter housing 14 is connected to a water supply tube 16 attached on a kitchen or bathroom water faucet for supply tap water to the water filter 10. The water faucet is not shown in the drawings. A lower, right side, portion of the water filter housing 14 is shown cutaway to illustrate the tap water to be treated, shown as arrows 18, moving upwardly from the water supply tube 16, next to the inside of the housing 14 and next to the outside of the filter cartridge 12.

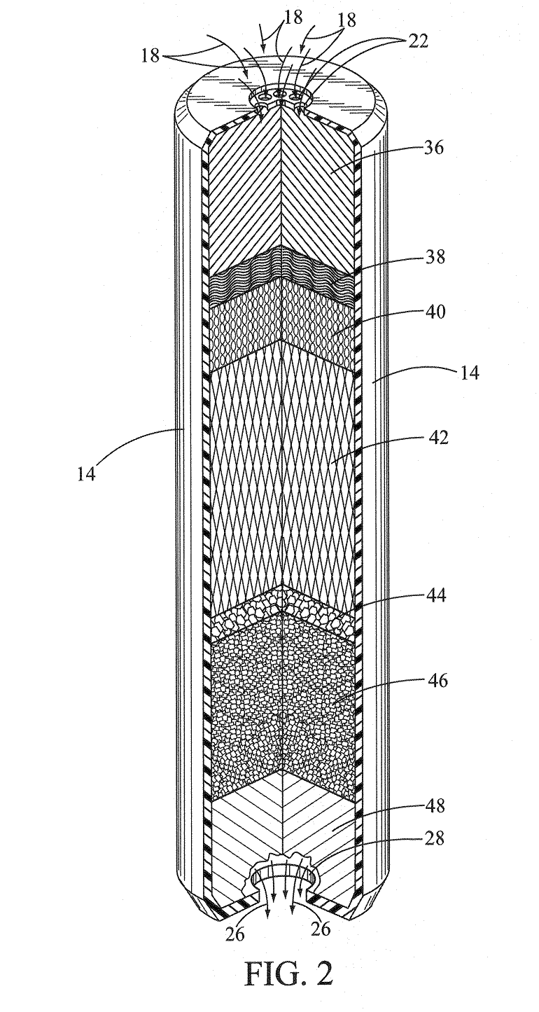

A top portion 20 of the filter housing 14 is cutaway to illustrate the tap water 18 moving upwardly and entering intake port holes 22 in the top of the filter cartridge 12. A bottom portion 24 of the filter housing 14 is cutaway to illustrate treated water, shown as arrows 26, being discharged out a discharge port hole 28 in the bottom of the filter cartridge 12. The discharge port hole 28 is shown in FIG. 2. The treated water 26 then exits into a bottom portion 30 of an inverted “J” shaped water spigot 32 attached to a side of the filter housing 14. The treated water 26 is shown being discharged out a top portion 34 of the spigot 32 for use by the user of the drinking water filter 10.

In FIG. 2, a perspective view of the tubular filter cartridge 12 is shown and cutaway to illustrated the micro pads and a combination of compound mixtures used to purify the tap water 18.

An intake 50 micron pad 36 is mounted in the top of the cartridge 12 and next to the intake port holes 22. The pad 36 is used for the initial filtering of large contaminates, such as rust.

Ion exchange fibers 38 are disposed below the intake micron pad 36 and are used for filtering out heavy metals, such as copper, mercury and lead from the tap water 18.

Below the Ion exchange fibers 38 is a combination of resins 40. The resins 40 are a mixture of a cation exchange resin, in a H plus or minus form, and a cation exchange resin, in a Na plus or minus form. The resins 40 provide additional protection by filtering out copper, mercury and lead from the tap water. The resins 40 make up 10 to 20 percent of the compound mixture and specifically 15 percent of the total mixture, in the cartridge.

Disposed below the cation exchange resins 40 is a large amount, in a range of 40 to 60 percent of the compound mixture and specifically 50 percent, is a mixture 42 of a hybrid anti-arsenic sorption, an anion exchange resin and an inorganic component. This compound mixture 42 removes phosphate and sulfate anions, that can interfere with the effective removal of arsenic. Also, the mixture removes inorganic arsenic, which is associated with increased risk of skin, bladder, lung, kidney and prostate cancer.

Below the mixture 42 is a small amount, in a range of 1 to 4 percent or specifically 2 percent of a silver impregnated activated carbon 44. This type of carbon is acid washed and removes cancer causing organic contaminates and creates a bacteriostatic environment.

Placed below the silver activated carbon 44 is a mixture of non-washed and washed activated carbon 46. The carbon 46 is in a range of 25 to 35 percent or specifically 30 percent of the compound mixtures in the cartridge 12 and is used further remove the copper, mercury and lead from the tap water. Also, the activated carbon is used to remove chlorine, chlorine taste and odor, TTHM's, pesticides, herbicides, and other organic pollutants associated with cancer and adverse reproductive outcomes.

The layer of activated carbon 46 is disposed above a final discharge 5 micron pad 48. While the above compound mixtures are shown in order and one on top of the other, it should be kept in mind, the mixtures can be reversed in order or intermixed for purifying the tap water as discussed above.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. A drinking water filter connected to a water supply source for treating tap water, the water filter comprising:
a sealed water filter cartridge, the filter cartridge having intake port holes in a top thereof and adapted for receiving the tap water therethough;
an intake micron pad disposed next to the intake port holes in the cartridge, the intake micron pad for filtering out large contaminates, such as rust;
a combination of a mixture of a cation exchange resin, in a H plus or minus form, and a cation exchange resin, in a Na plus or minus form disposed below the intake micron pad in the cartridge, the mixture of cation exchange resins provide for addition protecting in filtering out copper, mercury and lead;
a mixture of a hybrid anti-arsenic sorption, an anion exchange resin and an inorganic component disposed below the below the cation exchange resins in the cartridge, the sorption, anion exchange resin and inorganic component used to filter out phosphate and sulfate anions and inorganic arsenic;
a mixture of non-washer and washed activated carbon disposed below the impregnated active carbon in the cartridge, the carbon used to remove chlorine, chlorine taste and odor, TTHM's, pesticides, herbicides and other organic pollutants associated with cancer; and
a discharge micron pad disposed below the activated carbon in the cartridge and next to a discharge port hole in a bottom of the cartridge, the discharge micron pad used to filter out any remaining floating contaminates and give the treated water sparkling clarity.

2. The water filter as described in claim 1 further including a silver impregnated activated carbon disposed between the sorption, anion exchange resin and inorganic component and the washed and unwashed activated carbon in the cartridge, the silver impregnated activated carbon used to remove cancer causing organic contaminates and creates a bacteriostatic environment in the cartridge;

3. The water filter as described in claim 1 further including Ion exchange fibers disposed between the intake micron pad and the mixture of cation exchange resins in the cartridge, the fibers used for filtering out heavy metals, such as copper, mercury and lead.

4. The water filter as described in claim 1 wherein the mixture of hybrid anti-arsenic sorption, anion exchange resin and inorganic component comprises 40 to 60 percent of the compound mixture in the water filter cartridge.

5. The water filter as described in claim 1 wherein the mixture of silver activated carbon comprises 25 to 35 percent of the compound mixture in the water filter cartridge.

6. A drinking water filter connected to a water supply source for treating tap water, the water filter comprising:
a sealed water filter cartridge, the filter cartridge having intake port holes in a top thereof and adapted for receiving the tap water therethough;
an intake 50 micron pad disposed next to the intake port holes in the cartridge, the intake micron pad used for filtering out large contaminates, such as rust.
Ion exchange fibers disposed below the intake micron pad in the cartridge, the fibers used for filtering out heavy metals, such as copper, mercury and lead;
a combination of a mixture of a cation exchange resin, in a H plus or minus form, and a cation exchange resin, in a Na plus or minus form disposed below the ion exchange fibers in the cartridge, the mixture of cation exchange resins provide for addition protecting in filtering out copper, mercury and lead;
a mixture of a hybrid anti-arsenic sorption, an anion exchange resin and an inorganic component disposed below the below the cation exchange resins in the cartridge, the sorption, anion exchange resin and inorganic component used to filter out phosphate and sulfate anions and inorganic arsenic;
a silver impregnated activated carbon disposed below the below the sorption, anion exchange resin and inorganic component in the cartridge, the silver impregnated activated carbon used to remove cancer causing organic contaminates and creates a bacteriostatic environment in the cartridge;
a mixture of non-washer and washed activated carbon disposed below the impregnated active carbon in the cartridge, the carbon used to remove chlorine, chlorine taste and odor, TTHM's, pesticides, herbicides and other organic pollutants associated with cancer; and
a discharge 5 micron pad disposed below the activated carbon in the cartridge and next to a discharge port hole in a bottom of the cartridge, the discharge micron pad used to filter out any remaining floating contaminates and give the treated water sparkling clarity.

7. The water filter as described in claim 6 wherein the mixture of hybrid anti-arsenic sorption, anion exchange resin and inorganic component comprises 40 to 60 percent of the compound mixture in the water filter cartridge.

8. The water filter as described in claim 6 wherein the mixture of silver activated carbon comprises 25 to 35 percent of the compound mixture in the water filter cartridge.

9. The water filter as described in claim 6 wherein the mixture of cation exchange resins comprise 10 to 20 percent of the compound mixture in the water filter cartridge.

10. The water filter as described in claim 6 wherein the silver impregnated carbon comprises 1 to 4 percent of the compound mixture in the water filter cartridge.

11. The water filter as described in claim 6 wherein the mixture of non-washed and washed activated carbon comprised 25 to 35 percent of the compound mixture in the water filter cartridge.

12. A drinking water filter connected to a water supply source for treating tap water, the water filter comprising:
a water filter housing adapted for receiving tap water therein and discharging treated tap water therefrom;
a sealed water filter cartridge, the water filter cartridge received inside the water filter housing for removing contaminates in the tap water, the filter cartridge having intake port holes in a top thereof and adapted for receiving the tap water therethough;
an intake 50 micron pad disposed next to the intake port holes in the cartridge, the intake micron pad for filtering out large contaminates, such as rust.
Ion exchange fibers disposed below the intake micron pad in the cartridge, the fibers used for filtering out heavy metals, such as copper, mercury and lead;
a combination of a mixture of a cation exchange resin, in a H plus or minus form, and a cation exchange resin, in a Na plus or minus form disposed below the ion exchange fibers in the cartridge, the mixture of cation exchange resins provide for addition protecting in filtering out copper, mercury and lead;
a mixture of a hybrid anti-arsenic sorption, anion exchange resin and an inorganic component disposed below the below the cation exchange resins in the cartridge, the sorption, anion exchange resin and inorganic component used to filter out phosphate and sulfates anions and inorganic arsenic;
a silver impregnated activated carbon disposed below the below the sorption, anion exchange resin and inorganic component in the cartridge, the silver impregnated activated carbon used to remove cancer causing organic contaminates and creates a bacteriostatic environment in the cartridge;
a mixture of non-washer and washed activated carbon disposed below the impregnated active carbon in the cartridge, the carbon used to remove chlorine, chlorine taste and odor, TTHM's, pesticides, herbicides and other organic pollutants associated with cancer; and
a discharge 5 micron pad disposed below the activated carbon in the cartridge and next to a discharge port hole in a bottom of the cartridge, the discharge micron pad used to filter out any remaining large contaminates, such as rust.

13. The water filter as described in claim 12 wherein the mixture of hybrid anti-arsenic sorption, anion exchange resin and inorganic component comprises 40 to 60 percent of the compound mixture in the water filter cartridge.

14. The water filter as described in claim 12 wherein the mixture of silver activated carbon comprises 25 to 35 percent of the compound mixture in the water filter cartridge.

15. The water filter as described in claim 12 wherein the mixture of cation exchange resins comprise 10 to 20 percent of the compound mixture in the water filter cartridge.

16. The water filter as described in claim 12 wherein the silver impregnated carbon comprises 1 to 4 percent of the compound mixture in the water filter cartridge.

17. The water filter as described in claim 12 wherein the mixture of non-washed and washed activated carbon comprised 25 to 35 percent of the compound mixture in the water filter cartridge.
